(19) United States
(12) Patent Application Publication
(10) Pub. No.: US 2003/0058973 A1
(43) Pub. Date: Mar. 27, 2003

(54) Adaptive pulse frame rate frequency control for digital amplifier systems

(76) Inventor: Michael J. Tsecouras, Carrollton, TX (US)

Correspondence Address: TEXAS INSTRUMENTS INCORPORATED, P O BOX 655474, M/S 3999, DALLAS, TX, 75265

(21) Appl. No.: 10/068,492

(22) Filed: Feb. 5, 2002

Related U.S. Application Data
(60) Provisional application No. 60/295,149, filed on Jun. 1, 2001.

(51) Int. Cl. H04B 1/18; H04L 27/06

(52) U.S. Cl. 375/344; 455/192.2

(57) ABSTRACT

A system and method of integrating digital switching amplifiers into systems with low amplitude front-end tuners, among other things, to eliminate shielding and EMI filtering associated with signals, power and ground. An adaptive frequency programmable pulse frame rate digital switching amplifier scheme using either look-up tables or appropriate algorithms, ensures by design, the elimination of critical interference frequency generation.

### SUMMARY OF THE INVENTION

1. Field of the Invention

This invention relates generally to switching amplifiers, and more particularly to a system and method of adaptive pulse frame rate frequency control for minimization of electromagnetic contamination associated with digital amplifier systems within audio-visual (AV) receivers, mini-component systems, televisions (TV) sets, and the like.

2. Description of the Prior Art

Critical frequency band interference is a natural byproduct of switching amplifiers, and is independent of specific architectural approaches and implementations associated with the switching amplifiers. This characteristic is particularly problematic when integrating switching amplifiers into systems with low amplitude front-end tuners, such as AM/FM/TV band systems. Such integration is presently possible using expensive and bulky metal shielding in association with liberal application of EMI filters on signals, power and ground.

Understanding the key contributors to the EMI spectrum generation accommodates design of a system that can predictably avoid specific frequency spectra. Integrating switching amplifiers into a data communication system generates noise at the frame pulse rate, also including the even and odd harmonics of the pulse frame frequency. Higher frequency EMI is generated at the High Frequency (HF) clock, and used for the PWM generator such that HF clock harmonics are also present in the EMI emissions. The noise energy is emitted from the silicon die and is affected by the particular board layout using the switching amplifier(s). The amplitude associated with the noise energy is proportional to the loop areas of the power, signal and ground return areas. In view of the foregoing, it can be appreciated that near field containment of EMI energy due to the contamination of power and ground requires significant design effort. Many EMI filters and shields must, for example, be utilized to ensure that a switching amplifier sub-system can co-exist with a highly sensitive RF front end, such as that associated with RF tuner devices. Such tuners however, have selectivity and certain frequency rejection circuitry integrated therein to avoid degradation due to cross-talk (bleed-through) of neighboring stations. Elimination of frequencies generated by a switching amplifier therefore only requires elimination of frequencies which are in the pass band of the tuner's user-selected frequency. Practically, caution must be exercised to also avoid nearby frequencies to local oscillator frequencies and intermediate frequencies within the IF band customarily used in associated receiver technologies.

EMI generally is always present at some amplitude; and frequency spurs associated with such EMI is easily correlated with switching rates, pulse frame rates and the PWM High Frequency clock for communication systems impacted by such EMI. Modern systems passing EMI generally require the system enclosure, input and output signal cables, and AC mains to limit generation of EMI energy in order to conform to specific country or regional EMI standards. Even the most robust EMI compliant systems suffer from sources of self-contamination however, due to near field and board level EMI conducted and radiated emissions.

Brute force methods are useful to reduce the amplitude of EMI noise signals generated by a switching amplifier. These methods, however, add cost and are time consuming to design and optimize. Various manufacturing tolerances must be considered to ensure a robust design for high volume manufacturing and typically add to the system weight, cost and design cycle time. Some of these methods include, but are not limited to 1) use of extensive metal shielding providing a ‘Faraday cage’ around the emitting source, 2) use of output L-C lowpass filters, e.g. 2^{nd} order to 6^{th} order, with 4^{th} order being most commonly used, 3) use of high frequency (EMI) filters using ferrite beads, T-filters and the like on power and ground points, all associated with the power supply, and 4) use of EMI filtered connectors to pass all power and signals into and out of the metal Faraday cage.

Spread spectrum switching controller techniques are useful as well to reduce the amplitude of EMI noise signals generated by a switching amplifier. Although such techniques reduce energy in many frequency bands, these techniques often retain sufficient energy in certain critical energy bands and therefore still require use of additional brute force EMI containment devices such as described above.

In view of the above, there is a need for an adaptive frequency programmable pulse frame rate switching amplifier capable of ensuring by design, the elimination of critical interference frequency generation. Such a switching amplifier should generate EMI noise signals in certain critical frequency bands only outside frequencies of interest.

### SUMMARY OF THE INVENTION

The present invention is directed to a switching amplifier that inherently does not produce EMI in certain critical frequency bands. The switching amplifier produces EMI only in frequency bands that are outside the frequency of interest. Two parameters necessary to ensure that interference in a certain frequency band of interest is not generated include 1) the ‘keep out band’ for EMI and 2) the frequency range of the digital switching amplifier necessary to meet acceptable THD, efficiency and frequency response. The ‘keep out band’ is known by application and is often related to the frequency of an AM radio station or an FM radio station, for example, that the user would like to listen to or record. Similarly, the ‘keep out band’ could be related to a television station that could either be viewed or recorded. Other applications may further include, but are not limited to cell phones or other transceivers.

Knowing the frequency of the ‘keep out band’ for EMI via user selection as described above, the present system and method of adaptive pulse frame rate frequency control can then be used to change the digital switching amplifier frequency when the user selects a new frequency band for listening, recording or viewing. This can be done, for example, by changing the pulse frame frequency via a Programmable Digital Asynchronous Sample Rate Converter according to the most preferred embodiment of the present invention.

Fixed frequency switched amplifiers have predictable frequencies associated with generation of the EMI noise spurs (spikes). Regardless of whether AM, FM, or TV applications are used, there is only a small frequency band with carrier and modulated frequencies (information content) for a given ‘keep out band’. These applications can all be accommodated with a system in which the pulse-frame frequency need only change by less than a factor of two. Optimization of normal output L-C filters can therefore remain fixed, even though the pulse frame frequency may be changed to a new value dependent on user selection of the AM/FM/TV frequency. Further, the actual information being received is already limited in both bandwidth and dynamic range from the source (station, cable, etc.). Small changes in frequency response and dynamic range therefore, are believed by the present inventor to not limit the overall channel performance when source limitations are considered.

More specifically, one embodiment of the present invention is directed to an adaptive pulse frame rate frequency control system that receives user selected frequency information such as AM, FM, or TV signals. The control system incorporates at least one digital amplifier and also includes a look-up table or algorithm to determine a proper pulse frame frequency necessary to eliminate critical frequency band interference by the at least one digital amplifier. Due to the actual number of ‘keep out band’ frequencies and mathematical relationships (ratios) of those to one another, there is not a need to have a unique pulse-frame frequency for each AM/FM/TV station that is selected by the user. Instead, only a few pulse-frame frequencies are necessary; and these can be mapped to specific user-selected AM/FM/TV stations. According to one embodiment, output control data bits for proper pulse-frame frequency selection are decoded and used to control a digital asynchronous sample rate converter master clock generator. The master clock generator is then used to re-clock a digital asynchronous sample rate converter such that the sample rate converter will output audio data at the new sample rate. A digital amplifier uses audio clocks, also at the new sample rate, to process the audio data output from the sample rate converter, such that output switching via the digital amplifier is performed at the new pulse-frame rate before it is finally filtered and processed via a loudspeaker, for example.

In one aspect of the invention, a method and associated system are implemented to eliminate critical frequency band interference by a switching amplifier such that overall channel performance is not limited as a result of small changes in system frequency response and system dynamic range due to changing the pulse frame frequency. Generally, actual information being received by the present adaptive pulse frame rate frequency control system will already be limited in both bandwidth and dynamic range from the source, e.g. station, cable.

In still another aspect of the invention, adaptive pulse frame rate frequency control for digital amplifier systems is implemented in which there is not a need to have a unique pulse-frame frequency for each AM/FM/TV station selected due to the actual number of ‘keep out band’ frequencies and mathematical relationships (ratios) of those to one another.

In yet another aspect of the invention, a method and associated structure are implemented to eliminate critical frequency band interference by a switching amplifier in which pulse-frame frequencies for each AM/FM/TV station are mapped to specific user-selected AM/FM/TV stations via a look-up table to determine which pulse frame to implement.

Still another aspect of the invention is associated with a system and method implemented to eliminate critical frequency band interference by a switching amplifier in which pulse-frame frequencies for each AM/FM/TV station are mapped to specific user-selected AM/FM/TV stations via algorithmic calculations to determine which pulse frame to implement.

Still another aspect of the invention is associated with a system and method implemented to optimize performance by selecting (programming) a switching frame rate i.e., by programming a digital asynchronous sample rate converter's clock generator frequency based on minimal interference between AM/FM/TV, the switching frame rate, and the PWM High Frequency clock.

### BRIEF DESCRIPTION OF THE DRAWINGS

Other aspects, features and attendant advantages of the present invention will be readily appreciated as the invention become better understood by reference to the following detailed description when considered in connection with the accompanying drawings in which like reference numerals designate like parts throughout the figures thereof and wherein:

FIG. 1 is a high level block diagram illustrating a scheme for generating a digital asynchronous sample rate converter master clock according to one embodiment of the present invention; and

FIG. 2 is a simplified block diagram illustrating an adaptive pulse frame rate frequency controlled digital amplifier system suitable for use with the digital asynchronous sample rate converter master clock generation scheme depicted in FIG. 1 according to one embodiment of the present invention.

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

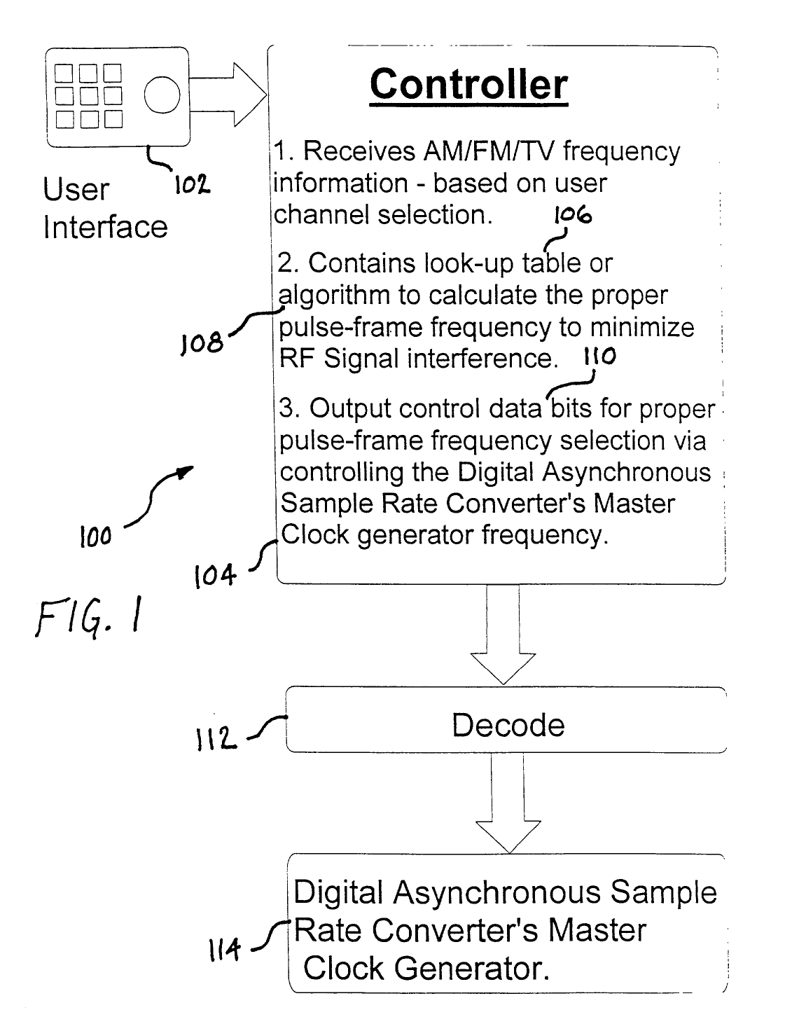

FIG. 1 is a high level block diagram illustrating one embodiment of the present adaptive pulse frame rate frequency control process 100. The process 100 commences when a user provides frequency information via a user interface such as a keypad 102 to a controller 104. The controller 104 can be a computer or otherwise include a data processing device such as a CPU, micro-controller, DSP, or other device capable of processing the user selected frequency information. The controller 104 can include a look-up table 106 of frequencies or an algorithm 108 capable of calculating the proper pulse frame frequency in response to the user selected frequency information. The look-up table 106 of frequencies (e.g., desired pulse frame frequencies) versus AM/FM/TV stations desired for listening/recording can be constructed to minimize interference in the keep-out bands for the frequencies related to the source selected. The look-up table 106 most preferably contains desired pulse frame frequencies in which neither the pulse frame frequency nor its harmonics (including the span frequencies related to the bandwidth of the information) can be either multiples or sub-multiples of the AM/FM/TV band frequencies as selected by the user. As stated herein before, selection of the programmed pulse frame frequency(s), the frequency multiple(s) and sub-multiple(s) should also not interfere with the IF and LCO as required by the receiver type selected. After processing the user selected frequency information, the controller 104 generates the requisite output control data bits 110 for proper pulse-frame frequency selection. The output control data bits 110 are then communicated to a decoder 112 to generate the requisite control data. Thus, when the user selects a given station on the AM/FM/TV band, the controller 104 commences to retrieve the proper pulse frame rate that will not interfere with the frequencies of the selected program material. The controller 104 updates a digital asynchronous sample rate converter master clock generator 114 using the control data generated via decoder 112 to obtain the new proper pulse-frame frequency selection. The digital asynchronous sample rate converter master clock generator 114 continues to output this frequency until the user selects another source. At that point, the controller 104 again retrieves the proper pulse frame rate that will not interfere with the frequencies of the newly selected program material. The controller 104 updates the digital asynchronous sample rate converter master clock generator 114 with the newest values necessary to obtain the newest proper pulse-frame frequency selection. Each time another selection is made, the look-up table 106 is retrieved, and/or the algorithm 108 is set into operation, and a correct digital asynchronous sample rate converter master clock generator 114 frequency is selected.

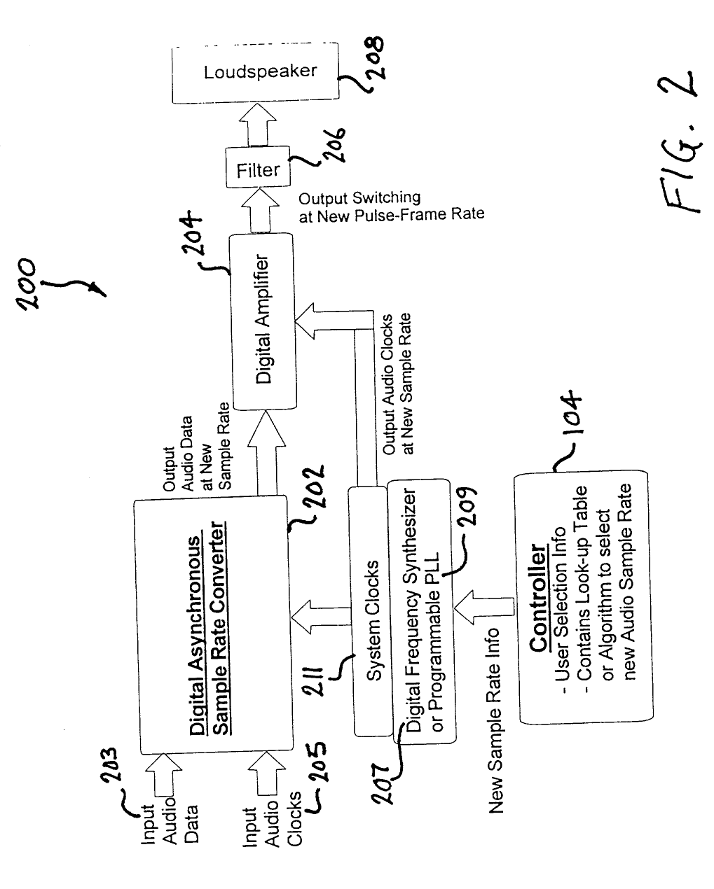

Looking now at FIG. 2, a simplified block diagram illustrates an adaptive pulse frame rate frequency controlled digital amplifier system 200 suitable for use with the digital asynchronous sample rate converter master clock generation scheme 100 depicted in FIG. 1 according to one embodiment of the present invention. The digital amplifier system 200 importantly can be seen to employ a digital asynchronous sample rate converter 202. Such sample rate converters are well known to those skilled in the sample rate converter art, and so specific details regarding the operating characteristics of the sample rate converter 202 will not be discussed herein to better preserve clarity and brevity. It is well known to those skilled in the sample rate conversion art, for example, to implement sample rate conversion in a hybrid digital/analog domain using a digital-to-analog (D/A) converter followed by an analog-to-digital (A/D) converter. The D/A converter runs at the input sample rate while the A/D converter is controlled by the output sample rate. If the output sample rate is lower, an analog anti-aliasing filter is provided between them. Performing sample rate conversion in the digital domain has been a research/development topic for more than a decade. The article by R. E. Crochiere and L. R. Rabiner, “Interpolation and decimation of digital signals-A tutorial review,” Proc. IEEE, vol. 69, pp. 300-331, March 1981, is an excellent reference for understanding fundamental insights from early research results in the art area. The present invention is not so limited however; and it is anticipated that the present invention may also be implemented using appropriate analog-to-digital (ADC) sample rate conversion techniques that do not require first converting a digital input signal to an analog signal. Such an implementation may, for example, simply employ an ADC to process an analog input signal provided directly by an external device. The processed signal could then be communicated to a data processing device such as a computer, CPU, micro-controller, digital signal processor (DSP), or other appropriate data processing device to alter the sample rate of the signal that is ultimately passed on to the digital amplifier system. With continued reference now to FIG. 2, the digital asynchronous sample rate converter 202 depicted in the adaptive pulse frame rate frequency controlled digital amplifier system embodiment 200 receives input audio data 203 as well as input audio clocks 205 in a manner also well-known to those skilled in the digital asynchronous sample rate converter art. The digital asynchronous sample rate converter master clock generator 114 discussed herein before is most preferably implemented using, for example, either a digital frequency synthesizer 207 or a programmable phase locked loop 209 such as depicted in FIG. 2. The present invention is not so limited however, and it will be appreciated by those skilled in the art that any means can be used to generate the digital asynchronous sample rate converter master clock 114 so long as it is programmable via the output control data bits 110 to achieve proper selection of the desired pulse-frame frequency. The controller 104 generates the requisite output control data bits 110 necessary for the digital frequency synthesizer 207 or programmable phase locked loop 209 to generate the system clocks 211 associated with the digital asynchronous sample rate converter 202 and the digital amplifier 204 portion of the system 200. The digital asynchronous sample rate converter 202 is then re-clocked via the system clocks 211 to output audio data at a new proper sample rate constructed to minimize interference in the keep-out bands for the frequencies related to the source selected as stated herein before. Similarly, the digital amplifier 204 is also re-clocked using audio clocks at the new sample rate. The digital amplifier 204 then processes the audio data and the audio clocks at the new sample rate to switch its output at the new pulse-frame rate in response to the AM/FM/TV band frequency data selected by the user such as discussed herein before. The output signal from the digital amplifier 204 is then passed through an appropriate filter 206 into a loudspeaker 208 such that critical frequency band interference caused by EMI generally associated with the digital switching amplifier 204 is avoided.

In view of the foregoing, it can be appreciated the present invention presents a significant advancement in the art of digital switching amplifier systems. Further, this invention has been described in considerable detail in order to provide those skilled in the data communication art with the information needed to apply the novel principles and to construct and use such specialized components as are required. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims that follow. For example, although various embodiments have been presented herein with reference to particular functional architectures and algorithmic characteristics, the present inventive structures and methods are not necessarily limited to such a particular architecture or set of characteristics as used herein.

What is claimed is:

1. A digital amplifier adaptive pulse frame rate frequency control system comprising:
a sample rate converter;
a programmable controller operational in response to user selected input frequency data to generate control data bits; and
a system clock generator operational to generate a sample rate converter master clock signal in response to the control data bits such that the sample rate converter generates output data at a sample rate determined by the control data bits.

2. The digital amplifier adaptive pulse frame rate frequency control system according to claim 1 wherein the programmable controller comprises a data processing device selected from the group consisting of a computer, a digital signal processor (DSP), a CPU, and a micro-controller.

3. The digital amplifier adaptive pulse frame rate frequency control system according to claim 1 wherein the system clock generator comprises a frequency controller selected from the group consisting of a digital frequency synthesizer, and a programmable phase-locked loop.

4. The digital amplifier adaptive pulse frame rate frequency control system according to claim 1 wherein the system clock generator is further operational to generate audio clock signals at the sample rate determined by the control data bits.

5. The digital amplifier adaptive pulse frame rate frequency control system according to claim 4 wherein the system clock generator is further operational to generate sample clock signals at the sample rate determined by the control data bits.

6. The digital amplifier adaptive pulse frame rate frequency control system according to claim 4 further comprising a digital amplifier responsive to the system clock generator audio clock signals and the sample rate converter output data such that the digital amplifier output switches at a pulse-frame rate determined by the system clock generator audio clock signals and the sample rate converter output data.

7. The digital amplifier adaptive pulse frame rate frequency control system according to claim 6 wherein the digital amplifier output further switches at a pulse-frame rate to minimize interference associated with keep-out bands for frequencies related to a desired source.

8. The digital amplifier adaptive pulse frame rate frequency control system according to claim 7 wherein the keep-out bands are associated with frequencies selected from the group consisting of AM, FM and TV band frequencies.

9. The digital amplifier adaptive pulse frame rate frequency control system according to claim 7 wherein the keep-out bands are associated with frequencies selected from the group consisting of radio frequency (RF), intermediate frequency (IF), and Local Control Oscillator (LCO) frequencies.

10. The digital amplifier adaptive pulse frame rate frequency control system according to claim 7 wherein the keep-out bands are associated with wireless communication frequencies selected from the group consisting of cellular telephone frequencies and Bluetooth frequencies.

11. The digital amplifier adaptive pulse frame rate frequency control system according to claim 1 wherein the sample rate converter comprises a digital asynchronous sample rate converter.

12. A digital amplifier adaptive pulse frame rate frequency control system comprising:
a digital asynchronous sample rate converter operational to generate output audio data in response to input audio data, an input audio clock and a master clock;
a programmable controller operational in response to user selected input frequency information to generate control data bits, wherein the input frequency information is selected from the group consisting of wireless, cellular telephone, Bluetooth, RF, IF, LCO, AM, FM, and TV band frequencies;
a decoder operational to decode the control data bits; and
a system clock generator operational to generate the master clock in response to the decoded control data bits such that the digital asynchronous sample rate converter generates the output data at a sample rate determined by the user selected input frequency information.

13. The digital amplifier adaptive pulse frame rate frequency control system according to claim 12 wherein the programmable controller comprises a data processing device selected from the group consisting of a computer, a DSP, a CPU, and a micro-controller.

14. The digital amplifier adaptive pulse frame rate frequency control system according to claim 12 wherein the system clock generator comprises a frequency controller selected from the group consisting of a digital frequency synthesizer, and a programmable phase-locked loop.

15. The digital amplifier adaptive pulse frame rate frequency control system according to claim 12 wherein the system clock generator is further operational to generate audio clocks at the sample rate determined by the user selected input frequency information.

16. The digital amplifier adaptive pulse frame rate frequency control system according to claim 15 further comprising a digital amplifier responsive to the system clock generator audio clocks and the digital asynchronous sample rate converter output audio data such that the digital amplifier output switches at a pulse-frame rate determined by the user selected input frequency information.

17. The digital amplifier adaptive pulse frame rate frequency control system according to claim 16 wherein the digital amplifier output switches at a pulse-frame rate to minimize interference with keep-out bands associated with the input frequency information.

18. A digital amplifier adaptive pulse frame rate frequency control system comprising:
digital asynchronous sample rate converting means for generating output audio data in response to input audio data, an input audio clock and a master clock;
programmable controlling means for generating control data bits in response to user selected input frequency information, wherein the input frequency information is selected from the group consisting of RF, IF, LCO, AM, FM, TV, wireless, cellular telephone and Bluetooth band frequencies;
decoding means for decoding the control data bits; and
clock generating means for generating the master clock in response to the decoded control data bits such that the digital asynchronous sample rate converting means generates the output data at a sample rate determined by the user selected input frequency information.

19. The digital amplifier adaptive pulse frame rate frequency control system according to claim 18 wherein the programmable controlling means comprises a data processing device selected from the group consisting of a computer, a DSP, a CPU, and a micro-controller.

20. The digital amplifier adaptive pulse frame rate frequency control system according to claim 18 wherein the clock generating means comprises a frequency controller selected from the group consisting of a digital frequency synthesizer, and a programmable phase-locked loop.

21. The digital amplifier adaptive pulse frame rate frequency control system according to claim 18 wherein the clock generating means is further operational to generate audio clocks at the sample rate determined by the user selected input frequency information.

22. The digital amplifier adaptive pulse frame rate frequency control system according to claim 21 further comprising a digital amplifying means for generating an output signal that switches at a pulse-frame rate determined by the user selected input frequency information in response to the clock generating means audio clocks and the digital asynchronous sample rate converting means output audio data.

23. The digital amplifier adaptive pulse frame rate frequency control system according to claim 22 wherein the digital amplifying means output signal further switches at a pulse-frame rate that minimizes interference with keep-out bands associated with input frequency information.

24. The digital amplifier adaptive pulse frame rate frequency control system according to claim 18 wherein the clock generating means is further operational to generate sample clocks at the sample rate determined by the user selected input frequency information.

25. A method of controlling the pulse-frame rates for a digital amplifier output signal comprising the steps of:
providing a pulse-frame rate frequency control system having a programmable controller, a system clock generator, and a digital asynchronous sample rate converter operational to generate output audio data at a first sample rate in response to input audio data and further in response to input audio clocks;
communicating user selected input frequency data to the controller such that the controller generates control data bits determined by the user selected input frequency data;
communicating the control data bits to the system clock such that the system clock generates a master clock for the digital asynchronous sample rate converter at a new sample rate and further such that the system clock generates output audio clocks at the new sample rate; and
adapting the digital asynchronous sample rate converter output audio data at a first sample rate to conform to the new sample rate determined by the master clock.

26. The method according to claim 25 further comprising the steps of:
providing a digital amplifier having output switching responsive to the digital asynchronous sample rate converter output audio data and further responsive to the output audio clocks at the new sample rate; and
communicating the digital asynchronous sample rate converter output audio data and the output audio clocks at the new sample rate to the digital amplifier such that the digital amplifier operates to change its output switching pulse-frame rate from a first pulse-frame rate to new pulse-frame rate.

27. The method according to claim 25 further comprising the steps of:
providing a digital amplifier having output switching responsive to the digital asynchronous sample rate converter output audio data and further responsive to the output audio clocks at the new sample rate; and
communicating the digital asynchronous sample rate converter output audio data and the output audio clocks at the new sample rate to the digital amplifier such that the digital amplifier operates to change its output switching pulse-frame rate to a new pulse-frame rate that substantially minimizes interference minimizes interference with keep-out bands associated with the frequency group consisting of AM, FM, and TV band frequencies.

28. The method of claim 25 wherein the step of communicating user selected input frequency data to the controller such that the controller generates control data bits determined by the user selected input frequency data comprises the step of providing a look-up table of pulse-frame frequencies (output digital asynchronous sample rate converter clock generator frequencies) versus station data selected from the group consisting of RF, IF, LCO, AM, FM, TV station, wireless, cellular telephone and Bluetooth frequencies, that can be accessed by the controller to determine the control data bits.

29. The method of claim 25 wherein the step of communicating user selected input frequency data to the controller such that the controller generates control data bits determined by the user selected input frequency data comprises the step of providing an algorithm to select pulse-frame frequencies (output digital asynchronous sample rate converter clock generator frequencies) versus station data selected from the group consisting of RF, IF, LCO, AM, FM, TV station, wireless, cellular telephone and Bluetooth frequencies, that can be accessed by the controller to determine the control data bits.
